(19) United States
(12) Patent Application Publication
(10) Pub. No.: US 2008/0025489 A1
(43) Pub. Date: Jan. 31, 2008

(54) Automated group communication

(75) Inventors: Steve Edger Dye, Richardson, TX (US); Xiaoying Liu, Plano, TX (US); Xinwu Zhu, Carrollton, TX (US); Charles Kalat, Richardson, TX (US); Thomas Anthony Zegub, Richardson, TX (US); Nancy Catherine Holley, Plano, TX (US); Charles John Fitzgerald, Plano, TX (US); Lawrence David Chambers, Garland, TX (US)

Correspondence Address: GROOVER & Associates, BOX 802889, DALLAS, TX, 75380-2889, US

(73) Assignee: Aastra USA, Inc., Frisco, TX (US)

(21) Appl. No.: 11/811,906

(22) Filed: Jun. 11, 2007

Related U.S. Application Data
(60) Provisional application No. 60/812,537, filed on Jun. 9, 2006.

(51) Int. Cl. H04M 3/42

(52) U.S. Cl. 379/202.01

(57) ABSTRACT

Systems and methods for connecting a plurality (even a large plurality) of recipients or destinations to an originating caller across, for example, a phone network. In preferred embodiments, the phones are connected within a single private branch exchange (PBX), which can be distributed across individual nodes over large distances. The size of the groups included in the destinations can be indefinitely large and can be configured to parse recipients as desired. In preferred embodiments, an originator selects from among various pre-defined groups (or, alternatively, the originator defines new groups) and initiates a one-way or two-way call to recipients. The recipients' control over refusing the announcement are optional, but preferably include non-override options so that emergency announcements may not be ignored or blocked.

### CROSS-REFERENCE TO RELATED APPLICATIONS

This application claims priority from U.S. provisional patent application 60/812,537 filed on Jun. 9, 2006, which is hereby incorporated by reference.

### BACKGROUND AND SUMMARY OF THE INVENTION

The present application relates to telephony, and more particularly to an automated group communication (AGC).

### DESCRIPTION OF BACKGROUND ART

In many situations, there is need for emergency notification of large groups of people over a telephone system. In disasters or other emergencies, information may come into the possession of an individual or small group who may be responsible to notify others, for example, to get out of a building (or into one), to notify or interact with a response team, or to notify an even larger group. The size of groups that may need to be contacted can include individuals, small groups, parts of buildings (such as a single floor, or a single company that occupies parts of floors), entire buildings, campuses of multiple buildings (or parts thereof), enterprises that span multiple sites, or entire populations.

Selectively communicating with such varied groups can be a difficult problem, particularly since telephones, which are the most common form of person-to-person communication, can be in use or otherwise make a recipient unreachable. An emergency call to an in-use telephone can go unnoticed, or an emergency call can be blocked or interrupted by other callers. Further, some systems for emergency notification may only be usable from a specific location or may not be able to dynamically react or change coverage zones or recipients in response to the situation.

There is thus a need in the art for an emergency notification system that cannot be blocked or interrupted, which provides secure access from any location, facilitates real-time changes in directions or information, supports large-scale, two-way, real-time communication, allows provisioning for zoning or segmenting recipients in any combination, and which can scale to thousands of destinations and still execute in seconds.

Automated Group Communication

In one example embodiment, the present innovations include systems and methods for connecting a plurality (even a large plurality) of recipients and/or trunks to an originating caller across, for example, a phone network. The size of the groups included in the destinations can be indefinitely large and can be configured to parse recipients as desired.

In a preferred embodiment, the present innovations include a system that permits an originator to selectively contact one or more (preferably) pre-defined and configurable groups with an emergency communication that selectively cannot be blocked or ignored (for example, in the case of digital devices as end points). The communication can preferably be provisioned one-way or two-way, or selectably two-way, depending on choices or inputs made by the originator and/or recipients. In this example embodiment, the originator first accesses the service by making a call and (in some embodiments) using an access code. Once access is established, a pre-announcement phase occurs and a pre-announcement tone sounds. During the announcement phase, the originator makes an announcement or enters a conference (i.e., two-way communication) with the recipients. Finally, the method includes a cleanup phase, wherein the originator and destination devices are disconnected or idled.

The disclosed innovations, in various embodiments, provide one or more of at least the following advantages:

Cannot go unnoticed;

Cannot be blocked or interrupted;

Provides secure/controlled access from any location;

Facilitates real-time changes in directions/information;

Supports large-scale, two-way, real-time communication;

Provides provisioning for segmentation/zoning of any combination;

Scales to thousands of destinations and still executes in seconds.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows an overview flowchart for process steps consistent with an example of the present innovations.

FIG. 2 shows a diagram of call function occurrences consistent with an example of the present innovations.

FIG. 3 shows a diagram of network connections consistent with an example of the present innovations.

FIG. 4 shows a diagram of network connections consistent with an example of the present innovations.

### DETAILED DESCRIPTION OF THE PREFERRED EMBODIMENTS

The numerous innovative teachings of the present application will be described with particular reference to the presently preferred embodiment (by way of example, and not of limitation).

The present innovations described herein include, for example, an automated group communication system that takes advantage of the Meet Me and Extended Meet Me conference capability. In one example embodiment, the innovations allow the capability to make an announcement (one or two way communications) with one or more phones. In preferred embodiments, the phones are connected within a single private branch exchange (PBX), though recipients can be distributed across other networks, such as separate stand-alone PBXs, the PSTN, adjunct paging systems, etc. (It is noted that the PBX architecture can be distributed, so that the individual nodes may exist across large distances (e.g., across the country) from one another.) The originator need not be part of the PBX itself, though in preferred embodiments, outside callers accessing the system must enter an authorization code. In an example embodiment, the originator accesses the feature using a directory number, and preferably, an authorization code. The size of the groups that can be included in the announcement can be indefinitely large.

The capabilities of the destination phones (or other devices) can vary, though preferably they are digital devices, and have speaker capability. Analog devices can also be used as recipients, though the ability of the system or call manager to modify settings on an analog device may be limited. Depending on the implementation choices of the present innovations, destinations can selectively or automatically have the ability to talk back to the originator's page. Such choices could be made either by the originator or by the destination (or another party), either prior to the call or at initiation, or during the call. Or, such choices could be pre-provisioned.

In preferred embodiments, existing calls at a destination device are automatically put on hold (though this option could be selectively enforced, or permissively enforced as well). Other phone “modes” or states at the destination device (such as, for example, call forwarding, do not disturb, etc.) can also be automatically, selectively, or permissively overridden in favor of the announcement. Such options are preferably configurable in the present innovations. Other options and details are included in the current specification.

In preferred embodiments, a program manages the connections between the recipients and originator, through the switch. A single PBX is preferably used, though this can be a distributed PBX with a node architecture. Alternately, recipients can be across other networks, such as the PSTN, the Internet, etc. Preferably, one call manager program can control and manage the connections, and manages the conference bridge resources, whether all on a single node, or distributed across multiple nodes and/or networks.

In preferred embodiments, a database stores definitions of groups. Each group includes a number of recipients, preferably uniquely defined, for example, by their PBX port (or other unique physical location identifier), such as by using the call manager's telephony switch port, or by other means (e.g., the user's port as identified by rack, shelf, slot or line card interface, and circuit on the line card). Each port can be digital or analog. Multiple groups are preferably defined, and groups can have overlapping members. Groups can also comprise sets of other groups. Each member of a group will be a recipient or destination of a call sent to that group.

The call manager, which can reside remotely, the originator to the recipients in either a one-way or two-way announcement or conference, respectively. The call manager's database preferably includes the group definitions. Originators are required, in preferred embodiments, to enter some sort of access or identifier code before being permitted to use the AGC. For example, in a preferred embodiment, originators are defined by their DIRN and need an authorization code to access the AGC functions. Different authorization codes can permit an originator to access different functions of the AGC. For example, an originator with a low-level access code may only be able to establish a conference with limited groups, or a conference with limited interrupt capabilities; while an originator with higher level access may be able to access a larger set of groups, define new groups, or access AGC functions that permit higher level interrupt capabilities.

In one example embodiment, destinations are defined in terms of stations (such as digital or analog stations) or trunks (e.g., analog trunks, or digital interfaces). ITE (proprietary digital phones) or smart phones, or analog stations, for example, can also be used as destinations. In preferred embodiments, the call manager's database of potential recipients includes information necessary to issue commands to the recipient device so as to control the recipient device—setting speaker phone, putting pre-existing calls on hold, etc. Depending on the recipient device, some functions may be unavailable, such as initiating speaker functions on an analog phone without a speaker-phone capability. In such cases, for example, the analog phone would simply ring, while other phones with higher capability would initiate the higher level functions.

Because multiple AGC calls may be initiated and conducted in a single PBX at a given time, AGC calls preferably do not override one another. However, in some embodiments, overrides of AGC calls are enabled. For example, an AGC call for disaster information may be capable of overriding a non-disaster AGC. The hierarchy of AGC calls and overrides is definable within the call manager. Because destination station types are preferably pre-defined within the call manager's database, the functions and status of each station is preferably known to the call manager.

Other types of calls may also be distinguished so as not to be overridden, such as 911 calls or other AGC calls, for example. Other configuration options of preferred embodiments are described more fully below.

Some embodiments of the present innovations include a program on a server or other computer system to serve as an AGC monitor. The application preferably has connectivity to a CTI (Computer Telephony Integration) interface of the call manager. This server preferably has access to the call manager's database, which includes definitions of all potential AGC groups and destinations. The monitor preferably has access to the database, or has copied the database, of the call manager. As an AGC call is initiated, the monitor application can monitor and report in real time various metrics of the call. For example, the monitor application can keep track of which groups or recipients have been added, and which were not added. Such knowledge can be crucial, for example, in disaster situations, where knowing that a page or announcement was not received by certain individuals can enable the issuer to find other ways to inform those who were unable to receive the announcement. Other metrics can be monitored and recorded, such as who originated the call, who jointed, the duration, quality of the communication, or other diagnostic functions.

In another embodiment, one or more recipients can be designated as a recording port. This can provide, for example, real-time recording of the actual voice message or other message issued by the originator.

When an originator initiates a call, a display on the originator's phone preferably displays an identifier or name of the group. For example, if a tornado warning group is defined, that group may be identified by the term “TORNADO” which is displayed on the originator's station during the AGC call.

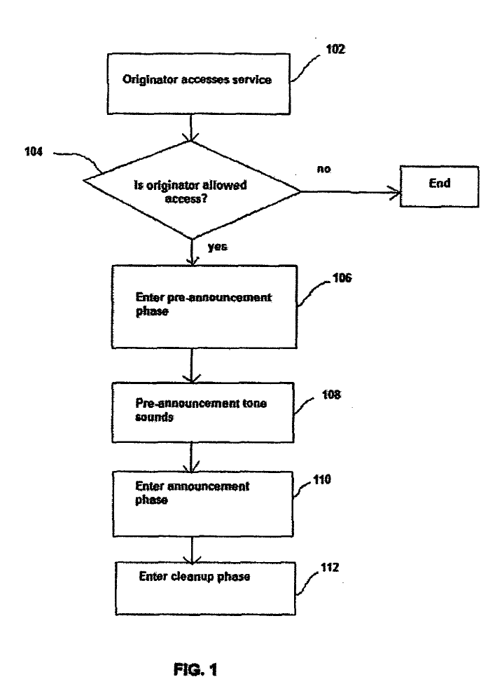

A simplified flow chart consistent with an embodiment of the present innovations is shown in FIG. 1. First, the originator accesses the service, for example, by making a call and using an access code (in preferred embodiments), or by being on a permitted list of originators (step 102). If the originator is allowed access (step 104), the method enters the pre-announcement phase (step 106), wherein actions are taken before playing optional tones or messages. Next, a pre-announcement tone is sounded, preferably to both destination and originating devices (step 108). Next, the method enters the announcement phase (step 110), where the originator makes an announcement or enters a conference. Finally, the method enters cleanup phase (step 112), when originator and destination devices are disconnected and/or idled, and other activities take place. It is noted that in preferred embodiments, for digital recipients, the calls can be configured so that the recipient cannot hang up or ignore the call until the originator hangs up, for example. Such capabilities may not be available with analog recipients. For example, analog recipients (such as analog trunks or phones) preferably respond to a seize immediate in order to become a recipient and complete the connection.

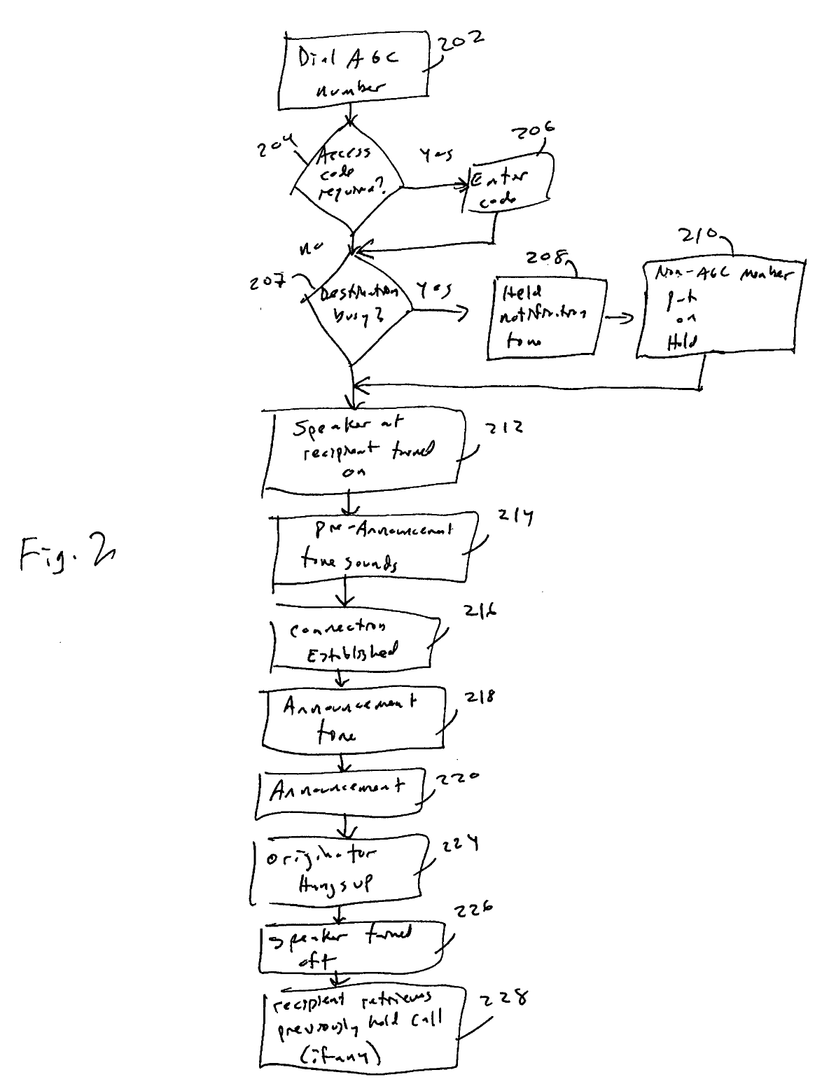

FIG. 2 shows a diagram of call activity according to the locations where they occur, including the originator, the destination station, and the connected party. In this example, an originator dials the AGC access number to access the service (step 202). If an access code is required (step 204), the originator enters the access code (step 206). Afterward, or if no access code is required, the destination station is idled. Or, if the destination is busy, a hold notification is sent (step 208) and the party to whom the destination station was connected is put on hold (step 210). Otherwise, the speaker at the destination is activated (step 212) and a pre-announcement tone sounds (step 214). The destination is then connected (step 216). When the destination party is connected, an announcement start tone notifies the originator (step 218) and the originator may speak the announcement (step 220) which will be heard at the destination station. When the originator is finished, the originator terminates the call by hanging up (step 224). The destination speaker is turned off and the call is disconnected (step 226). If a call was put on hold from the destination station, that call may be manually retrieved (step 228). It is noted that if a particular destination station is for some reason not connected to receive the communication, preferred embodiments include a notice of some kind (e.g., a flag or other notice) to let the originator know that not all recipients (and, preferably, which recipients) were not connected.

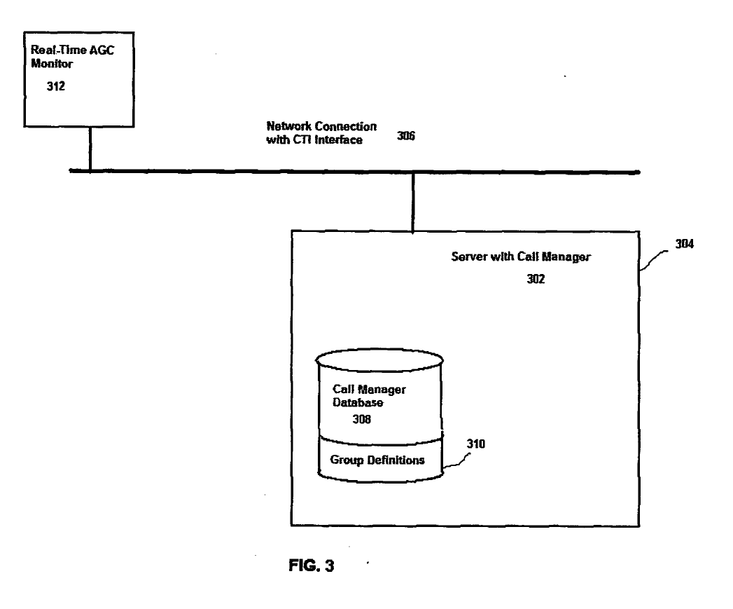

FIG. 3 shows an example embodiment of the present innovations. In this example, a call manager program 302 resides on a server 304 connected to a network (preferably with CTI interface) 306. In preferred embodiments, call manager 302 includes a call manager database 308 which has group definitions 310. Real-time AGC monitor 312 resides across the network connection 306 and can snoop or otherwise learn the contents of the group definitions stored at the call manager database 308. The monitor's functions are described above, and preferably include real-time reporting to the originator or other recipient of call metrics.

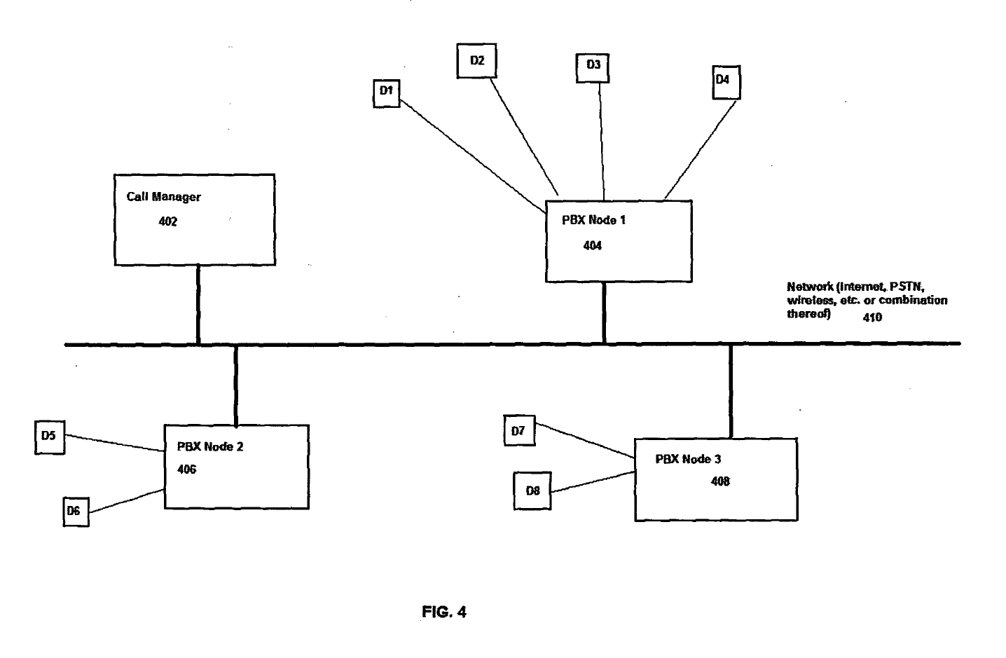

FIG. 4 shows a topology of network connections consistent with an example of the present innovations. In this example, call manager 402, and PBX nodes 1, 2, and 3 (404, 406, 408) are connected to a network connection 410. In preferred embodiments, PBX nodes are part of a distributed PBX and comprise a single virtual switch which covers disparate geographic areas. Network 410 can comprise a plurality of different types of network connections, such as the Internet, PSTN, wireless connections, and others, or any combination thereof capable of connecting the devices. Destination stations (or networks) (D1-D8) are variously connected to respective PBX nodes, as shown. In a preferred embodiment, one or more destinations are identified as members of groups for purposes of making AGC calls via call manager 402. The groups need not be part of the same PBX node. For example, Group One might comprise D1, D2, and D8, such that when Group One is selected as recipients of an AGC call, these destinations (D1, D2, and D8) are included in the call, while all other destinations are excluded. Other configurations are possible. It is noted that other elements to this network are not shown, such as routers, DSL repeaters, gateways, servers, etc. It is also noted that destinations D1-D8 may be soft or smart phones, or can be described in terms of trunks or stations with computer-like capability, or they may be simple analog phones.

In some embodiments, destinations D1-D8 do not correspond simply to devices, but to further networks where recipient devices may reside. For example, D1 may be a digital station, D2 may be an analog station, D3 may be a smart phone, D4 may be a PSTN connection to a device. D5 may be a paging system, attached to the network 410 through PBX node 2, for example, while D6 could be another, stand-alone, PBX with a recipient device attached thereto.

Following is a description of one example embodiment consistent with the present innovations. Also included is contextual information relating to an extended conference bridging system and method, consistent with implementing the present innovations.

The Automated Group Communication (AGC) feature of the present innovations preferably provides the capability of making an announcement to a group of PointSpan ITE phones with speakers (including but not limited to ITE 12S, ITE 12+, ITE 12SD, ITE 30SD, ITE-760 and ITE-780).

In one example, a station calls a pre-defined number and is connected with a group of PointSpan, speaker-enabled ITE phones. All of the destination phones will go off hook automatically and be connected to the originator. The destination phone will hear a Pre-announcement tone to indicate that an AGC announcement is going to be made. The originator will then hear a Start Announcement tone to indicate that the channel is open to speak to all connected destination phones. The name associated with the dialed AGC number will be displayed on both the originating and destination display phones. When the originator finishes the announcement and hangs up, the destination phones will be idled.

The AGC feature has configuration dependent options to: 1) override Do Not Disturb, 2) override of busy stations, and 3) allow both manual and automated initiation of conference capability at destination stations (conference capacity limited to bridge).

The AGC feature directory number is preferably defined using Man/Machine DIRN command. The command manages a list of eligible directory numbers that are allowed to call the AGC number, a name for the Group and a list of destination phones to be to be connected by the AGC originators. Other AGC settings such as tones and access code are also defined under the AGC feature directory number.

In an example embodiment, the present innovations include a feature that enables the creation of a new type of directory number—herein referred to as an AGC directory number. The AGC directory number preferably specifies the list of valid originating directory numbers, the list of destination stations, originator restrictions, other parameters.

In preferred embodiments, there are four phases for an AGC call; Origination, Setup, Announcement and Cleanup. (It is noted that other phases may be incorporated, or the example phases could be merged into fewer phases.)

As mentioned, the four phases of the preferred embodiments include origination, setup, announcement, and cleanup. These four phases, as preferably implemented, are described further. It is reiterated that the following descriptions are exemplary only, and not limiting, and can vary in implementation.

Origination Phase

Originating an AGC call can be restricted through the originating voice line directory number and/or a defined AGC access code.

Authorized Originators Only

A user can only originate an AGC call from a directory number defined within the AGC origination list. The origination list of directory numbers is defined in an AGC directory number command. This is the default choice.

Access Code Only

A user can originate an AGC call from any directory number, shared within the directory number allocation, and then entering the specific access code defined in the AGC directory number command.

Authorized Originators Plus Access Code

A user can only originate an AGC call from a directory number defined in the origination list and then enter the specific access code defined for the AGC directory number.

Authorized Originator or Access Code

A user can originate an AGC call from a directory number from the originating directory number list or from any directory number, shared within the directory number allocation list, and then enter the access code.

Unrestricted Access

A user can originate an AGC call from any directory number, shared within the directory number allocation without using an access code. This is a less preferred embodiment.

The originator preferably dials the AGC directory number to enter the Origination phase. If an access code is required, the system plays a ZIP tone to prompt the originator for additional digits. After verification of the originating directory number and/or access code, the call proceeds to the Setup phase. If the originator were to go on-hook during the Origination phase, the AGC call is preferably aborted and the destination phones are not interrupted.

Setup Phase

During the Setup phase, the action taken on the destination station depends on the AGC database configuration and the destination station's state when the AGC number is dialed. If the originator goes on-hook during the Setup phase, the destination stations will preferably be placed back into an idle condition.

The following options are preferably processed during setup of the AGC call.

Busy Override and Do Not Disturb Override Options

AGC can be configured to override a station that is busy or set in Do Not-Distrub. When the AGC call is being originated and the destination station is idle with DND set, if AGC is configured with “Do-Not-Disturb Override” enabled, the destination station will preferably be connected to the AGC call.

Busy override options can also be implemented. Some options are mentioned below.
No override: Busy stations are not interrupted by the AGC call.

Override all calls except for ACD (Automatic Call Distribution) calls: The busy stations are overridden except for ACD calls. The AGC page will be preferably played to all busy stations not on an ACD call.
Override all calls: All busy stations are overridden. The AGC page will be played to all busy stations.

AGC can be configured to override Non-Idle stations. When the AGC call is originated, the destination stations could be in various states: idle, dialing, on a call (internal, ATTN, trunk, IXL, ACD, conference), on hold (normal hold, hold-on-hold, swap hold, conference hold). If the destination phone is not in an idle state and AGC is configured for “Busy Override”, the active call will be placed on hold and the station will be connected to the AGC call. The destination station will NOT be interrupted in the following exceptions:
Destination station is in transition: If a destination station is in the process of making a call or termination a call, the station is idled and the system sets up the AGC page call as described for an idle destination station.
Destination station is in conversation with a non-ACD call: If busy override option is enabled, the destination's connected party is put on hold and is played an optional Held Party Notification Tone and optional Held Party Notification Message, if defined. The destination station's speaker is turned on to play an optional pre-announcement tone and optional pre-announcement message, if defined. The station is then connected to hear the announcement. If the busy override option is disabled, then the destination station is not interrupted by the AGC page call.
Destination is in conference: If the busy override option is enabled, the conference at the destination is put on hold. The system plays the optional Held Party Notification Tone to the conference bridge, if defined, and the conference continues with the conference on HOLD at the destination station. If all parties of the conference of the conference are destinations, the conference bridge is put on HOLD by all parties and each party can manually return to the conference after the AGC call ends. The destination station's speaker is turned on to play an optional pre-announcement tone and optional message, if defined. The station is then connected to hear the announcement. If busy override option is disabled, the destination station is not interrupted by the AGC call.
Destination station is held: If busy override option is enabled, the held destination puts the other (holding) party on hold. The destination station's speaker is turned on to play an optional tone and message as mentioned above, if defined. The station is then connected to hear the announcement. If busy override is disabled, the destination station is not interrupted.
Destination station is holding a third party for Transfer, Conference, or Hold and is involved in another call: If busy override is enabled, the destination puts the second call (not the AGC call) on hold. The Held Party Notification Tone and Message, if defined, are played to the held party immediately when the call is interrupted. The destination station is connected to the AGC page line in listen-only mode and its speaker is turned onto play optional pre-announcement tone and message. The station is then connected to hear the announcement. After the AGC call finishes, the held parties can be manually retrieved, in varying order. If busy override option is disabled, the destination station is not interrupted.
Destination station is connected to an Attendant Console: If busy override option is enabled, the system plays the Held Party Notification Tone to the attendant and disconnects the call from the attendant's switch loop (instead of placing the call on hold). The destination's speaker is turned on to play an optional pre-announcement tone and message the station is then connected to hear the announcement. If busy override is disabled, the destination is not interrupted.
Destination station is in DND mode: If DND override is enabled, the DND mode is overridden. The destination's speaker is turned on and plays announcements as described above. The station is connected to hear the announcement. If the DND override is not enabled, the destination is not interrupted.
Destination station is in conversation on an ACD call: If override active ACD call is enabled, the connected party (ACD call) is put on hold and listens to an optional Held Party Notification Tone and optional Message, if defined. The destination's speaker is turned on to play an optional tone and message, and the station is then connected to hear the announcement.
If override active ACD call is disabled, the destination station is not interrupted. Both parties are AGC Page Destination Parties: Both parties are put on hold and connected to the AGC page line in listen-only mode, and their speakers are turned on to play the optional pre-announcement tone and optional message. No Held Party Notification tone is necessary.

The setup phase also includes playing optional pre-announcement tones. During setup. a PointSpan fixed-length tone can be defined under the AGC DIRN to alert:
destination stations of the AGC setup;
connected parties being placed on hold;
originating parties that setup is complete and announcement can begin.

The announcement setup supports preferably three options defined by the AGC DIRN:
one-way connection from originator to destination;
one-way connection with optional conferencing by destination station user depressing conference button;
auto conferencing with destination stations.

Note, conferencing is limited by the bridge size defined by the Meet-Me DIRN defined within the AGC DIRN. Any remaining stations will have a one-way connections only.

Announcement Phase

In preferred embodiments, there are several options that are processed during the announcement phase of the AGC call. Maximum announcement duration specifies the max length of a live announcement to be given by the originator. A destination on-hook option allows the destination station the ability to go on-hook to be disconnected from the announcement.

Cleanup Phase

The AGC Cleanup phase starts when the originator places the originating station on-hook or the timer for the Maximum Announcement Duration expires. The originator and all destination stations are disconnected, idled, the speakers are turned off. Any associated conference bridges are idled. If an AGC page placed a call on hold at a destination station, that destination station user preferably retrieves the held call manually.

Man/Machine Configurations

AGC Directory Number

The new AGC Feature Directory Number, created or modified under DIRN command, includes the following Man/Machine fields:

AGC Directory Number (DRN)

This is the directory number used to initiate the AGC call.
   Name of AGC Directory Number (NGP)
An alphanumeric field used to provide a brief description of the AGC directory number. The maximum length is 8 characters.
   AGC Type (GPT)
An AGC may be defined as “announcement only”, “conference”, or “announcement/conference”
   AGC Meet-me Directory number (GMF)
The directory number of the meet-me group to use for AGC types “conference”and “announcement/conference”
   Class of Service (COS)
   Override Options:
Do Not Disturb override (DND) option: Yes or No
Busy Override (BSY) option: options include no override, override all calls except for ACD calls, or override all calls.
   Destination Station Termination of Paging (DOE):
Yes or No. The ability for destination stations to terminate an active page can be controlled. The destination stations can either be allowed or not allowed to terminate paging.
   Announcement Tones:
Destination Pre-announcement Tone (PAT): Any of PointSpan's fixed-length tones or ‘none’. The default value is ‘barge-in’. This option is preferably prompted after the pre-announcement message and maximum human announcement duration. If there is no pre-announcement message or human announcement defined, a pre-announcement tone is not allowed. This optional tone is played to the originator and all destination stations at the beginning of the Pre-announcement phase of the AGC call.
Held Party Notification Tone (HNT): Any of PointSpan's fixed-length tones or ‘none’. The default value is ‘barge-in’. This optional tone is played to party connected to a destination before they are placed on hold.
Originator Announcement Start Tone (SAT): Any of PointSpan's fixed-length tones or ‘none’. The default value is ‘barge-in’.
This optional tone is played only to the AGC originator at the beginning of the Announcement phase of the AGC call to indicate the system is ready to play the live announcement.
   Maximum Announcement Duration (MAD)
This field specifies the maximum amount of time the human-spoken announcement will be played. The range of values is 1 to 60 minutes or “no time limit applied”. The default value is 5 minutes.
   Originator Access Restriction—Restricted access option (RAP):
Authorized Originators Only
Access code Only
Authorized Originators and Access Code
Access Code for Non-Authorized Originators
No Restricted Access
   List of Authorized AGC Originator directory8 Numbers (OLF)
This list contains the voice line directory numbers that are allowed to dial the AGC Directory number to originate an AGC call. When displaying the AGC directory number, the list is displayed in sorted order.
   List of Destination ITE Speaker Phone Stations (DSP)
This list contains the port numbers of ITE speaker phones that are the destinations of the AGC call originated by dialing the AGC directory number. When displaying the AGC directory number, the list is displayed in sorted order.
   Searches
   Directory Number Search
Under DIRN/SEARCH command, Man/Machine allows user to search for a specific voice line directory number in all AGC groups and obtain a list of AGC groups for which the specified directory number is an authorized originator.
   Directory Number Search on Delete
Upon deletion of a voice line directory number, the system searches all AGC directory numbers. If the directory number is an authorized originator of a AGC directory number, Man/Machine indicates that voice line directory number is in use and lists the Paging Group directory number. It then removes the voice line directory number from the Paging Group directory number list prior to deleting the voice line directory number.
   AGC Membership Search
Under SRCH command, Man/Machine allows user to search for a specific authorized originator or destination station in all AGC groups and obtain a list of AGC groups in which the specified directory number is an authorized originator or in which the specified station is a destination station.
   Station Search on Delete
Upon deletion of a station the system searches all AGC directory numbers. If any AGC directory number uses the station as a destination, Man/Machine indicates that station is in use and lists the Paging Group directory number. It then removes the station from the Paging Group destination list prior to deleting the station.
   Table Validation (TVAL) (aka Database Validation)
The Man/Machine TVAL command is used to validate the AGC directory numbers for their list of Authorized originator directory numbers and list of destination stations. Man/Machine will validate if an AGC directory number points to an existing list and the facility types of the directory numbers or stations in the list are valid. If an error is found, the pointer to the no-exist list or the invalid member of the list will be removed by TVAL automatic correction.

According to a disclosed class of innovative embodiments, there is provided: A method of communicating with a plurality of recipients across a network connection, comprising the steps of: from an originator, identifying a plurality of recipients for a communication; connecting the originator and some or all the recipients, wherein if a recipient is currently on a call, that call is automatically put on hold.

According to a disclosed class of innovative embodiments, there is provided: A communication system, comprising: an originator; a plurality of recipients; a call manager; wherein the call manager is configured to establish a call between the originating station and the plurality of destination stations such that the call cannot be blocked or interrupted.

According to a disclosed class of innovative embodiments, there is provided: A method of communicating with a plurality of recipients, comprising the steps of: from an originator, accessing a function for establishing simultaneous communication between the originator and a plurality of receivers; selecting one or more groups of receivers for the communication; entering a pre-announcement phase, wherein selected receivers are remotely activated such that they can receive an announcement from the originator; entering an announcement phase wherein the originator enters a one-way or two-way communication with the selected receivers; and entering a cleanup phase, wherein the communication is closed, and wherein the selected receivers are remotely idled; wherein the one-way or two-way communication cannot be cancelled by the selected receivers.

According to a disclosed class of innovative embodiments, there is provided: A communication system, comprising: a computer program product on a computer readable medium residing on a server connected to a network; wherein the computer program product has access to a database that defines one or more groups, wherein the groups are configurable and include pre-selected receiving stations; wherein the computer program product is configured to control call access to the receiving stations; wherein the computer program product establishes a call to receiving stations selected at an originating station and wherein the call cannot be blocked or ignored.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, though the examples given herein mention PointSpan platforms, other platforms can be used to implement the innovations herein described.

For another example, the implementation of the application, preferably in a call manager, can be in various forms. Conference bridge resources, for example, can reside on a single node, multiple nodes, or all nodes.

For another example, some embodiments may have different rules for overriding previous calls. For example, 911 calls or other AGC calls are preferably not overridden.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A method of communicating with a plurality of recipients across a network connection, comprising the steps of:
from an originator, identifying a plurality of recipients for a communication;
connecting the originator and some or all the recipients,
wherein if a recipient is currently on a call, that call is automatically put on hold.

2. The method of claim 1, wherein the recipients are selected from the group consisting of: smart phones with speakers, smart phones without speakers, and analog phones.

3. The method of claim 1, wherein the recipients are uniquely identified in a database.

4. The method of claim 1, wherein the communication is one-way from originator to the recipients.

5. The method of claim 1, wherein the communication is a two-way conference.

6. The method of claim 1, wherein the destinations are selected as pre-defined groups.

7. The method of claim 1, further comprising:
prior to establishing the connection, sounding a pre-announcement tone to the group consisting of: the originator, the recipients, and the originator and recipients.

8. The method of claim 1, further comprising a monitoring application that monitors calls made from the originator to the recipients.

9. The method of claim 1, wherein the monitor application records and reports in real-time on one or more metrics of the call.

10. The method of claim 1, wherein an identification code and an authorization code must be entered at the originator in order to establish the connections to the recipients.

11. A communication system, comprising:
an originator;
a plurality of recipients;
a call manager;
wherein the call manager is configured to establish a call between the originating station and the plurality of destination stations such that the call cannot be blocked or interrupted.

12. The system of claim 11, wherein if a recipient is a digital recipient and is already on a call, the call is automatically put on hold by the call manager.

13. The system of claim 11, wherein the call is a one-way call.

14. The system of claim 11, wherein the call is a two-way conference.

15. The system of claim 11, further comprising a monitoring application that monitors calls made from the originator to the recipients.

16. The system of claim 11, wherein the monitor application records and reports in real-time on one or more metrics of the call.

17. A method of communicating with a plurality of recipients, comprising the steps of:
from an originator, accessing a function for establishing simultaneous communication between the originator and a plurality of receivers;
selecting one or more groups of receivers for the communication;
entering a pre-announcement phase, wherein selected receivers are remotely activated such that they can receive an announcement from the originator;
entering an announcement phase wherein the originator enters a one-way or two-way communication with the selected receivers; and
entering a cleanup phase, wherein the communication is closed, and wherein the selected receivers are remotely idled;
wherein the one-way or two-way communication cannot be cancelled by the selected receivers.

18. The method of claim 17, wherein the step of accessing includes entering an authorization code.

19. The method of claim 17, wherein in the cleanup phase, the selected receivers are returned to the status which they occupied prior to the pre-announcement phase.

20. The method of claim 17, wherein the pre-announcement phase includes a pre-announcement tone that sounds at the selected receivers to indicate an in coming announcement.

21-30. (canceled)
